(19) United States
(12) Patent Application Publication
(10) Pub. No.: US 2010/0109365 A1
(43) Pub. Date: May 6, 2010

(54) GLOVE BOX DOOR

(75) Inventors: Minoru SHIBATA, Aichi-ken (JP); Shinichi Sawada, Aichi-ken (JP); Yuichi Adachi, Aichi-ken (JP); Kazuaki Bito, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 12/609,301

(22) Filed: Oct. 30, 2009

(30) Foreign Application Priority Data
Oct. 30, 2008 (JP) 2008-280151

(51) Int. Cl. B60R 7/06; B60R 21/20

(52) U.S. Cl. 296/37.12; 280/728.3

(57) ABSTRACT

The glove box door includes an outer panel constituting a rear circumferential wall, an inner panel constituting a front circumferential wall, an airbag apparatus located between the outer panel and inner panel, a plurality of reinforcing ribs and void spaces formed around the airbag apparatus. The airbag apparatus includes a case that encases an airbag and an inflator and opens toward the rear, a holder that mounts the case on the outer panel, and a door that allows airbag emergence. The holder includes a joint flange and coupled to the outer panel by the joint flange. The outer panel is fabricated of hard synthetic resin having enhanced rigidity relative to the holder. A pair of mounting elements are assembled with the holder in such a manner as to be prevented from forward or backward movement. Mounting tongues formed on the case are secured to the mounting elements which are assembled with the holder and thus the case is mounted to the outer panel.

The Present application claims priority from Japanese Patent Application No. 2008-280151 of Shibata et al., filed on Oct. 30, 2008, the disclosure of which is hereby incorporated into the present application by reference.

### BACKGROUND OF THE INVENTION

1. Field of the Invention

The present invention relates to a door of a glove box of a vehicle that openeably closes off an opening located at the rear of the glove box. More particularly, the present invention relates to a glove box door that incorporates an airbag apparatus for knee protection.

2. Description of Related Art

JP 2002-347565A and JP 2002-356137A are illustrative of a glove box that incorporates an airbag apparatus for knee protection. The glove boxes shown in these references are so-called “no lid” type glove box that has an opening on top and no lid, and is rotatable about the bottom region. The box is pulled out by rotating the box about the bottom region. The airbag apparatus is mounted on a rear wall of the glove box so an airabg is deployable rearward from the rear wall.

However, since the rear wall of the glove box is formed of solid synthetic resin, the above configuration has a problem in terms of weight reduction.

U.S. Pat. No. 6,971,667 discloses a glove box of “with lid” type that includes a storage bin and a lid (door) which incorporates an airbag apparatus therein, although this apparatus is not intended to bolster knees of a passenger by an airbag in itself. The door of the glove box includes an outer panel and an inner panel, and the airbag is housed in a space between the outer panel and inner panel. When activated, the airbag is inflated and pushes out the outer panel rearward so the outer panel supported by the airbag bolsters the knees.

In the door of the above glove box, the housing space of the airbag extends over a wide area between the outer panel and inner panel, both in a vertical and left and right direction. This configuration hinders rigidity of the glove box door.

It is conceivable in this type of glove box assembly that the airbag apparatus is located between an outer panel and inner panel of the glove box door so as to deploy an airbag from the outer panel. In this case, however, it is expected, in operation, that an intense tensile force acts on a housing portion of the airbag and on a door that allows airbag emergence, such that the outer panel and inner panel are disconnected and outer panel slips from the inner panel toward an interior of vehicle, thereby hindering the opening of the door and deployment of the airbag.

### SUMMARY OF THE INVENTION

An object of the present invention is to provide a door of a glove box with an airbag apparatus that is rigid and light in weight, and deploys an airbag in a smooth fashion.

The door of a glove box for installation in front of a seat of a vehicle incorporates an airbag apparatus for knee protection. The glove box door includes an outer panel constituting a rear outer circumferential wall of the glove box door and an inner panel coupled to the outer panel and constituting a front outer circumferential wall of the glove box door. The airbag apparatus is located between the outer panel and inner panel. The outer panel includes an outer door region for opening to allow airbag emergence and is provided therearound with a weakened tearable portion. The glove box door further includes a plurality of reinforcing ribs extending between and connecting the outer panel and inner panel around the airbag apparatus in such a manner as to form void spaces between the outer panel and inner panel.

The airbag apparatus includes an inflatable airbag for emergence and deployment from the outer door region of the outer panel, an inflator that feeds inflation gas to the airbag, a case that houses and holds the airbag and inflator, a holder coupled to the outer panel and holding the case in order to mount the case to the outer panel, and a pair of mounting elements that are assembled with the holder in such a manner as to be prevented from forward or backward movement and assist the mounting of the case to the outer panel. The outer panel and holder are fabricated of synthetic resin, and the outer panel is fabricated of rigid synthetic resin relative to the holder.

The case includes a circumferential wall, a front wall that closes off the front side of the circumferential wall, an opening that opposes the front wall for allowing airbag emergence, and a pair of mounting tongues that are formed on opposite sides of the circumferential wall.

The holder includes a circumferential wall that is mounted around the case and extends in a generally anteroposterior direction, a holding panel that is joined with and extends from the rear end of the circumferential wall in such a manner as to cover the opening of the case, the holding panel being coupled to and holding the outer door region of the outer panel and provided with a flexible hinge located proximate the rear end of the circumferential wall, and a joint flange extending from the rear end of the circumferential wall and coupled to an area of the outer panel encircling the outer circumference of the tearable portion.

The mounting tongues of the case are secured to the mounting elements that are assembled with the holder by fixing means and thus the case is mounted to the outer panel.

The outer door region of the outer panel and the holding panel of the holder form, in combination, a door that covers the opening of the case and opens at airbag deployment due to tear of the tearable portion of the outer door region to provide an emergence opening that allows emergence of the airbag.

When the airbag apparatus installed on the glove box door of the invention is activated, the airbag inflates with inflation gas from the inflator and pushes the door that is comprised of the outer door region of the outer panel and the holding panel of the holder. Then the tearable portion formed around the outer door region gets torn and the door opens about the hinge and allows airbag emergence.

At this time, the door comprised of the outer door region of the outer panel and the holding panel of the holder is pushed rearward, i.e., away from the case, by the airbag. On the contrary, the case is subjected to a reaction force of the airbag acting forward. However, the mounting tongues formed on opposite sides of the circumferential wall of the case are secured to the mounting elements that are assembled with the holder in such a manner as to be prevented from moving forward or backward. Accordingly, the case is prevented from moving forward by the holder. Moreover, the area of the outer panel surrounding the tearable portion is prevented from moving backward since the joint flange of the holder is joined to the fore face of that area and holds that area. That is, it is prevented that the area of the outer panel surrounding the tearable portion and mounting tongues of the case move away from each other in an anteroposterior direction. With this configuration, if pushed by the airbag, the outer door region of the outer panel smoothly gets separated from the surrounding area due to tear of the tearable portion, and opens around the hinge of the holder together with the holding panel.

As a result, the airbag smoothly emerges from the emergence opening provided by the opening of the door and deploys rearward without being adversely affected by the outer panel since the outer panel is prevented from moving rearward.

On the other hand, the case is secured to the holder and the holder is coupled to the outer panel by the joint flange. That is, the case is mounted to the outer panel through intermediary of the holder, but is not directly mounted to the inner panel. Accordingly, even when subjected to a forward force upon airbag deployment, the case will not so act as to cause disconnection of the inner panel from the outer panel. Furthermore, the outer panel is fabricated of rigid synthetic resin relative to the holder, which is required to be soft in view of flexibility of the hinge, and therefore, the outer panel holds the case through intermediary of the holder in a stable manner.

Further, after airbag deployment, although the inertia force of the airbag pulls the case to the rear, the mounting elements to which the mounting tongues of the case are secured to are prevented from moving rearward by the holder, and are secured to the rigid outer panel by intermediary of the holder. Thus the case is stably held by the outer panel as well after deployment of the airbag.

Moreover, a plurality of the reinforcing ribs extend between and connect the outer panel and inner panel around the airbag apparatus in such a manner as to form a plurality of void spaces between the inner and outer panels. The void spaces conduce to lighten the weight of the glove box door and the ribs improve flexural and torsional rigidity of the glove box door.

Therefore, the glove box door of the invention is rigid and light in weight although having an airbag apparatus, and deploys an airbag in a smooth fashion.

In the glove box door of the invention, it is desired that each of the mounting elements is formed into a generally plate shape and the holder includes a pair of mounting beds each of which includes a front regulating region that regulates movement of the mounting element on the front side and a rear regulating region that regulates movement of the mounting element on the rear side so each of the mounting elements is inserted into a space formed between the front regulating region and rear regulating region and thus attached to the holder.

With this configuration, each of the mounting elements is easily assembled with the holder only by insertion into the space between the front regulating region and rear regulating region of corresponding mounting bed. The mounting elements assembled with the holder are clamped by the front regulating regions and rear regulating regions and prevented from forward or rearward movement. Thus the mounting tongues of the case are secured to the mounting elements in a stable manner.

In this case, it is desired that the front regulating region of each of the mounting beds includes a front wall that is connected to the circumferential wall of the holder and regulates movement of the mounting element on the front side, the front wall including a round through hole for receiving a bolt acting as the fixing means, and a pair of support walls that extend from opposite ends of the front wall toward the joint flange and coupled to the joint flange while being connected to the circumferential wall of the holder, the front regulating region thus having a “U” shaped section, and that each of the mounting elements includes a screw hole for receiving the bolt and the rear regulating region of each of the mounting beds is coupled to the circumferential wall and joint flange of the holder and supports the vicinity of the screw hole of the mounting element at more than one locations from the rear.

With this configuration, both of the front regulating region and rear regulating region of each of the mounting beds are coupled to both of the joint flange and circumferential wall. The joint flange extends vertically along the tearable portion of the outer panel whereas the circumferential wall of the holder extends in an anteroposterior direction in such a manner as to surround the case. Coupled to these two parts of the holder extending mutually orthogonally, the front regulating region and rear regulating region are enhanced in rigidity. Clamped by these front regulating region and rear regulating region, the mounting elements are positioned in a further stable fashion. Moreover, the front wall of the front regulating region is prevented from moving forward, i.e. moving away from the outer panel, by the support walls coupled to the circumferential wall and joint flange at opposite ends while abutting against an entire fore face of the mounting element. Therefore the front wall securely prevents the mounting element from moving forward. In addition, the rear regulating region are coupled to the circumferential wall and joint flange and supports the vicinity of the screw hole of the mounting element at more than one positions from the rear. Therefore the rear regulating region securely prevents the mounting element from moving rearward.

The inner panel of the glove box door may be formed of a single plate-shaped material. It may also be formed of more than one split parts. The former configuration will facilitate assembling of the glove box door compared to the latter because it unnecessitates a step for coupling the split parts.

If the inner panel is formed of more than one split parts, the inner panel can be comprised of, for instance, a cover panel that is fabricated of synthetic resin and located in front of the airbag apparatus and a peripheral panel that is fabricated of synthetic resin as well and located around the cover panel. The cover panel and peripheral panel are coupled together. In this case, the reinforcing ribs are formed integrally with either the outer panel or the peripheral panel of the inner panel and welded to the peripheral panel or the outer panel so the outer panel and peripheral panel are coupled together.

With this configuration, the outer panel and inner panel are easily coupled together by welding the reinforcing ribs extending from either the outer panel or peripheral panel of the inner panel to the counterpart by vibration welding or the like. Additionally, this configuration provides firm connection between the reinforcing ribs, outer panel and inner panel, thus preventing the inner panel from moving away from the outer panel and enhancing rigidity of the glove box door. Although the outer panel and inner panel are welded together by vibration-welding or the like, the welded portions will stay intact upon airbag deployment since the inner panel is not subjected to forward pressing force of the case as described above.

Furthermore, if at least part of the reinforcing ribs located in the vicinity of the holder is integral with the outer panel, the rigidity of the outer panel in the vicinity of the holder will be enhanced and thus assuring steady operation of the airbag apparatus.

### BRIEF DESCRIPTION OF DRAWINGS

FIG. 1 is a perspective view of a glove box door having an airbag apparatus for knee protection, as is mounted on a vehicle;

FIG. 2 is a schematic vertical section of an instrument panel of the vehicle where the glove box door of FIG. 1 is installed, taken along an anteroposterior direction;

FIG. 3 is a schematic vertical section of the glove box door of FIG. 1 as is mounted on the vehicle;

FIG. 4 is a schematic enlarged vertical section of the glove box door of FIG. 1 as is mounted on the vehicle;

FIG. 5 is a schematic horizontal section showing the way an inflator and a case of the airbag apparatus are fastened together;

FIG. 6 is a schematic perspective view of the inflator and case of FIG. 5;

FIG. 7 is a partial perspective view of a holder and its vicinity;

FIG. 8 is a schematic enlarged vertical section of a mounting bed of the holder of FIG. 8 and its vicinity;

FIG. 9 is a schematic horizontal section of the glove box door taken along line IX-IX of FIG. 8; and

FIG. 10 is a schematic vertical section of a modification of the glove box door.

### DESCRIPTION OF PREFERRED EMBODIMENTS

Preferred embodiments of the present invention are described below with reference to the accompanying drawings. However, the invention is not limited to the embodiments disclosed herein. All modifications within the appended claims and equivalents relative thereto are intended to be encompassed in the scope of the claims.

A glove box door 20 embodying the present invention includes a built-in knee-protecting airbag apparatus S and is located on the rear side of a glove box 13 on the lower side of the instrument panel or dashboard 4 and in front of a front passenger's seat.

Up/down, front/rear and left/right directions in this specification are intended to refer to up/down, front/rear and left/right directions in a condition that the glove box door 20 is closing an opening 14a of the glove box 13.

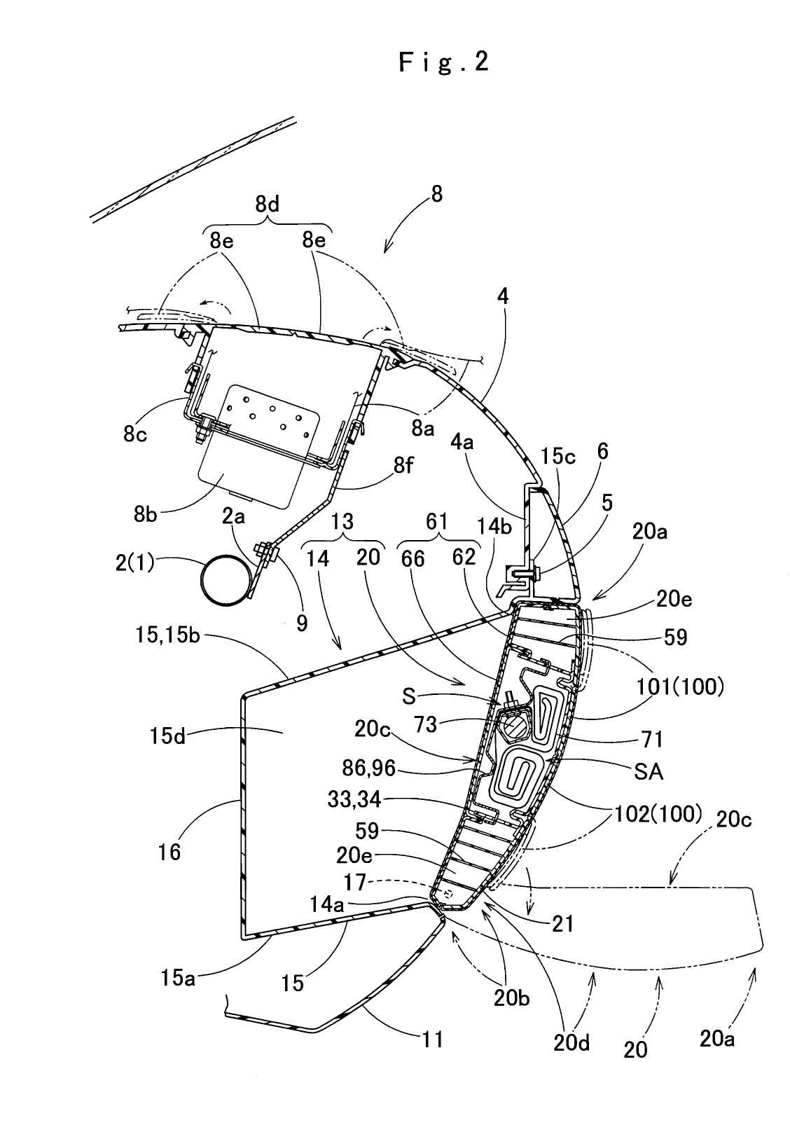

Referring to FIG. 2, the glove box 13 is of so-called “with lid” type including a box body 14 fabricated of rigid synthetic resin such as polypropylene and a door 20 that lids the opening 14a of the box body 14 in an openable fashion. The opening 14a is located on the rear side of the box body 14. The box body 14 is formed into a generally rectangular parallelepiped box including a circumferential wall 15 having a generally square cylindrical shape and a front wall 16 located at the front end of the circumferential wall 15. The circumferential wall 15 includes a lower wall 15a, an upper wall 15b facing the lower wall 15a above the lower wall 15a, left and right side walls 15d connecting left and right ends of the lower wall 15a and upper wall 15b respectively and opposing each other in a left and right direction, and a rectangular opening 14a at the rear. The front wall 16 is coupled to front ends of the lower wall 15a, upper wall 15b and side walls 15d and arranged generally vertically in such a manner as to oppose the opening 14a. Each of the left and right side walls 15d includes proximate the bottom of the rear end region a hinge pin 17 about which the glove box door 20 rotates when opening. Each of the side walls 15d is further provided with an unillustrated bracket for attachment to the vehicle body structure 1 and an unillustrated recess for engagement with a latch formed on the glove box door 20 proximate the top of the rear end region. The hinge pins 17 are for engagement with a later-described outer panel 21 of the glove box door 20 and the above-described latches are formed on the outer panel 21 as well.

The upper wall 15b includes a joint lug 15c to be bolt 5 fixed to a joint tongue 4a of the dashboard 4 as shown in FIG. 2. This joint is covered by a decoration panel 6. An undercover 11 is arranged below the glove box 13.

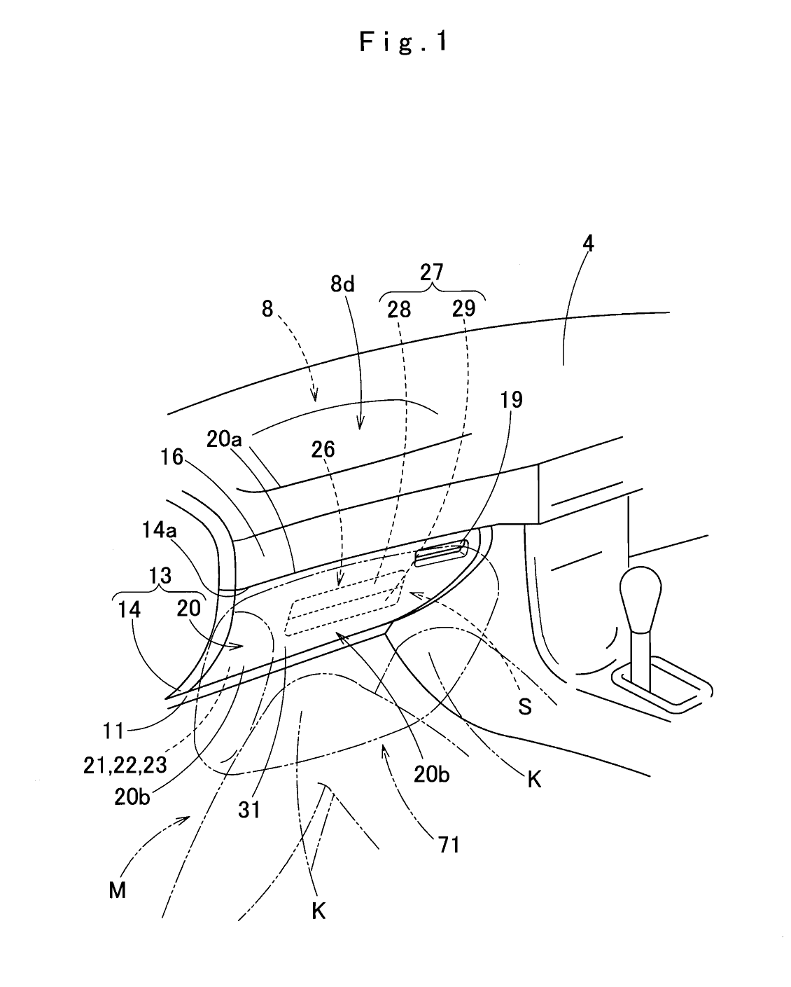

When moved to shut the opening 14a of the box body 14, the latches of the glove box door 20 described above are inserted into the recesses of the side walls 15d due to such biasing means as a spring, so that the door 20 keeps closing the opening 14a in a generally upright posture as shown in FIGS. 1 to 4. If the latches are disengaged from the recesses of the side walls 15d by pulling a lever 19 (FIG. 1), the glove box door 20 rotates rearward about the lower end 20b pivoting about the hinge pins 17 as indicated by double-dashed lines in FIG. 2, so that the opening 14a appears. When the door 20 opens, an unillustrated projection formed in the vicinity of the lower end 20b abuts against a stopper formed on the box body 14, thereby arranging the front plane 20c (FIG. 2) of the door 20 generally horizontally. The projection extends forward from the outer panel 21 via a later-described inner panel 61. Although not shown, a damping mechanism is mounted around the hinge pins 17 for suppressing abrupt opening of the door 20.

The hinge pins 17, lever 19, unillustrated latches, projection, stopper and damping mechanism are known components of this kind of glove box.

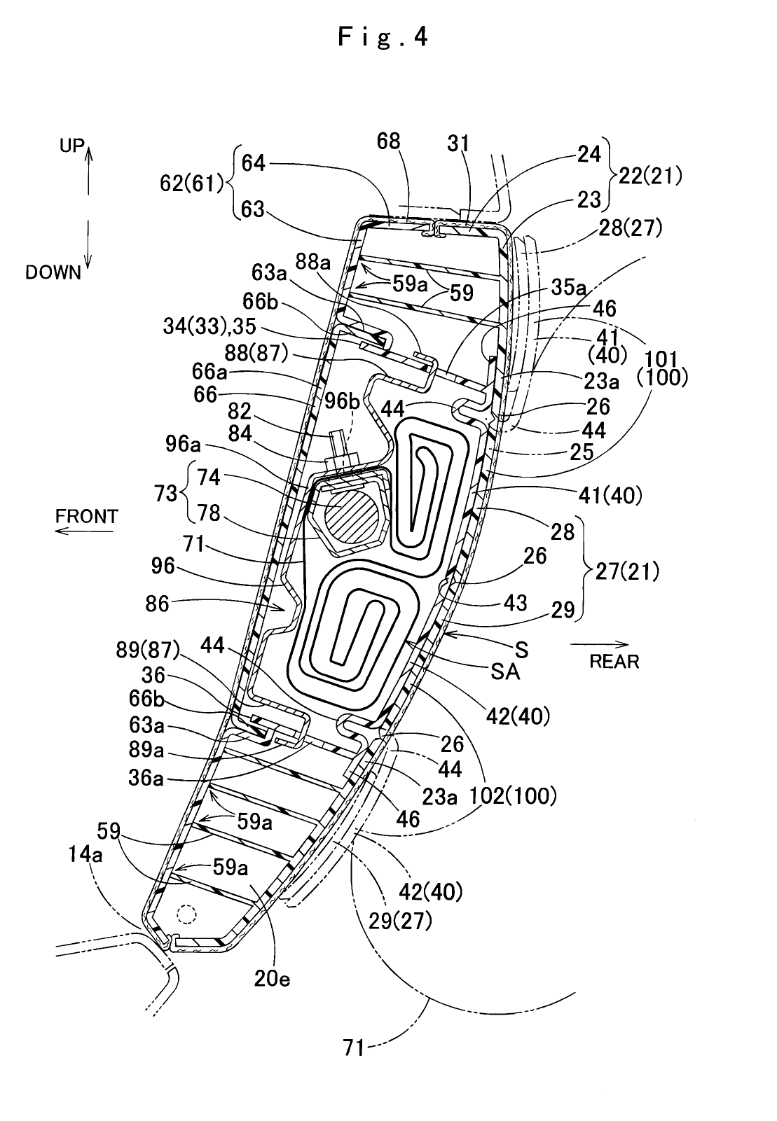

As best shown in FIG. 4, the door 20 of the glove box 13 includes an outer panel 21 which forms an outer circumferential wall of the rear face 20d of the door 20 as closed and an inner panel 61 forming an outer circumferential wall of the front face 20c. The door 20 has the knee-protecting airbag apparatus S between the outer panel 21 and inner panel 61. A plurality of reinforcing ribs 59 extend between the outer panel 21 and inner panel 61 around the airbag apparatus S and provide void spaces 20e between the outer panel 21 and inner panel 61.

The outer panel 21 includes an outer door 27 that covers the rear side of the airbag apparatus S and is pushed and opened by the airbag 71 at deployment and a surrounding region 22 that surrounds the outer door 27. The surrounding region 22 includes a rear panel portion 23 that is located at the rear of the void spaces 20e and an outer peripheral region 24 that extends forward and butts against a later-described outer peripheral region 64 of the inner panel 61. The rear panel portion 23 is integral with the numerous reinforcing ribs 59 that extend forward, i.e. toward the inner panel 61, in the shape of plate or stick. Each of the ribs 59 is coupled to a later-described front panel portion 63 of the peripheral panel 62 of the inner panel 61 at the front end 59a. In this specific embodiment, the front ends 59a of the ribs 59 are coupled to the front panel portion 63 by vibration welding. The outer panel 21, including the ribs 59, is fabricated of rigid synthetic resin such as filler-reinforced polypropylene for ensuring rigidity.

The outer door 27 includes an upper flap 28 and a lower flap 29 each having a rectangular plate shape. The flaps 28 and 29 are provided therearound with a tearable portion 26 which is so thin as to be torn when pushed by the airbag 71 under inflation. The tearable portion 26 is comprised of a continuous groove or a series of intermittent grooves formed on the front face of the outer panel 21, and forms a “8” shape as viewed from the rear (FIG. 1). The upper flap 28 is welded to a later-described upper section 41 of the holding panel 40 of the holder 33 by the fore face. When pushed by the airbag 71 at deployment, the upper flap 28 is separated from the rear panel portion 23 and lower flap 29 due to tear of the tearable portion 26 and opens upward together with the upper section 41. The lower flap 29 is located below the upper flap 28 and welded to a later-described lower section 42 of the holding panel 40 by the fore face. When pushed by the airbag 71 at deployment, the lower flap 29 is separated from the rear panel portion 23 and upper flap 28 due to tear of the tearable portion 26 and opens downward together with the lower section 42 as indicated by double-dashed lines in FIG. 4.

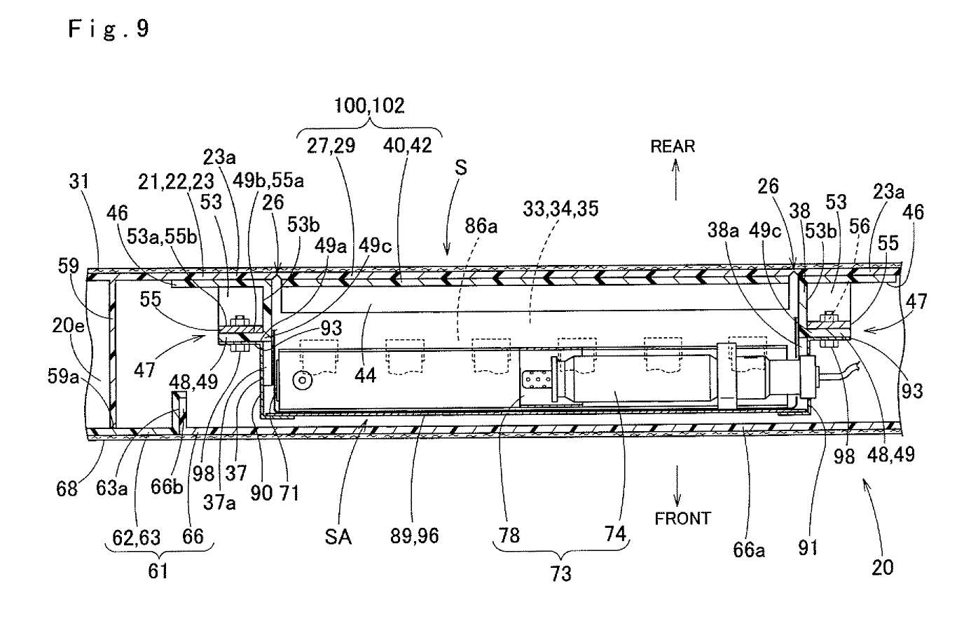

The rear panel portion 23 includes a peripheral region 23a that surrounds the tearable portion 26. As shown in FIGS. 4 and 9, the peripheral region 23a is a square annular region to which later-described joint flange 46 is connected. The joint flange 46 of this embodiment is vibration-welded to the peripheral region 23a as the holding panel 40 is welded to the outer door 27.

As shown in FIGS. 2 and 4, the inner panel 61 includes a cover panel 66 that covers the front side of the airbag apparatus S and has a generally rectangular plate shape and a peripheral panel 62 that is located around the cover panel 66. The cover panel 66 and peripheral panel 62 are fabricated of rigid synthetic resin such as filler-reinforced polypropylene for ensuring rigidity alike the outer panel 21. As shown in FIG. 4, the peripheral panel 62 includes a front panel portion 63 that is located in front of the void spaces 20e and an outer peripheral region 64 that extends rearward and butts against the outer peripheral region 24 of the outer panel 21. As described above, the reinforcing ribs 59 extending from the outer panel 21 are welded to the front panel portion 63.

As shown in FIGS. 4 and 9, the cover panel 66 includes a flat main body 66a located in front of the airbag apparatus S and flanges 66b that extend rearward from the outer peripheral edge of the main body 66a. The flanges 66b are fitted into fitting portions 63a of the front panel portion 63 of the peripheral panel 62, which are formed along inner peripheral edges of the front panel portion 63, and are further coupled to the front panel portion 63 by suitable adhesive or fastening structure. The cover panel 66 and peripheral panel 62 are so coupled together as to make the front face 20c of the glove box door 20 flush.

Referring to FIGS. 4 to 6, the airbag apparatus S includes an airbag 71 that protrudes from the outer panel 21 for deployment, an inflator 73 that supplies the airbag 71 with inflation gas and a case 86 that houses the airbag 71 and inflator 73 and is provided at the rear side with an opening 86a that allows emergence of the airbag 71. The airbag apparatus S further includes a holder 33 that connects the case 86 to the outer panel 21, a pair of mounting elements 55 that assist the mounting of the case 86 to the outer panel 21 and a door 100 that closes off the opening 86a of the case 86 and is openable when pushed by the airbag 71 under inflation. The door 100 is comprised of the outer door 27 of the outer panel 21 and holding panel 40 of the holder 33.

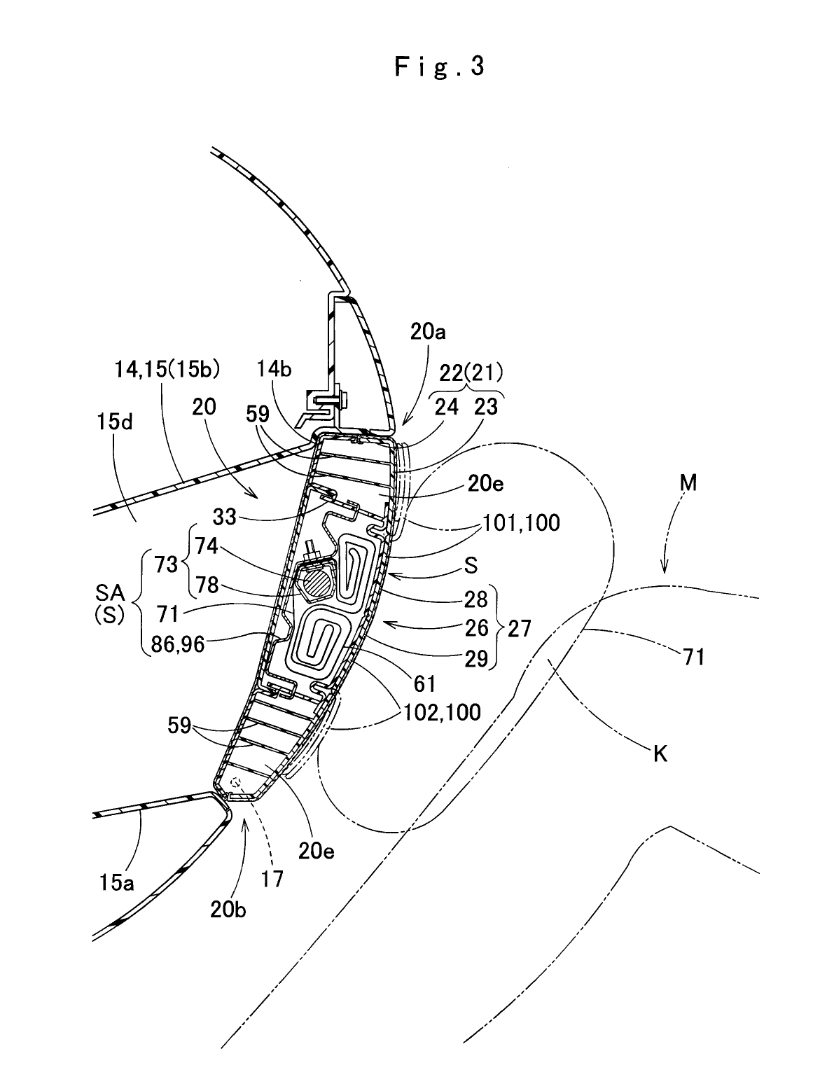

The airbag 71, upon inflation, pushes and opens the door 100 and emerges from the rear face 20d of the glove box door 20, and deploys rearward. The airbag 71 is inflatable into a generally rectangular plate shape elongated in a left and right direction as viewed from the rear, with a certain thickness in an anteroposterior direction as indicated by double-dashed lines in FIGS. 1 and 3, thus deployed in front of knees K of an occupant M.

Referring to FIGS. 4 to 6, the inflator 73 is to feed the airbag 71 with inflation gas. The inflator 73 is generally columnar in shape and is so arranged inside the airbag 71 that its axis extends along a left and right direction. In this specific embodiment, the inflator 73 includes a generally columnar body 74 and a retainer 78 that secures the body 74 to the case 86. The body 74 includes a generally columnar large-diameter portion 75 and a generally columnar small-diameter portion 76 located at the leading end of the large-diameter portion 75. The small-diameter portion 76 is provided with a plurality of gas discharge ports 76a that emit inflation gas when the inflator 73 is activated. The large-diameter portion 75 is provided on the end facing away from the small-diameter portion 76 with an unillustrated terminal to which a connector C of a lead wire R extending from a predetermined circuit is connected.

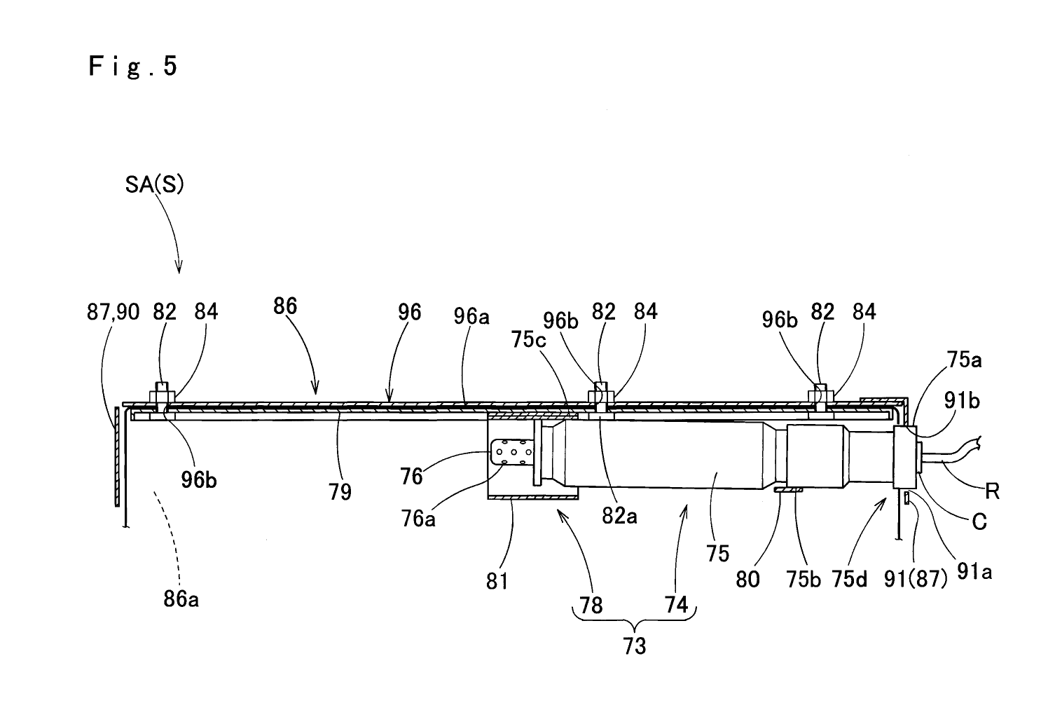

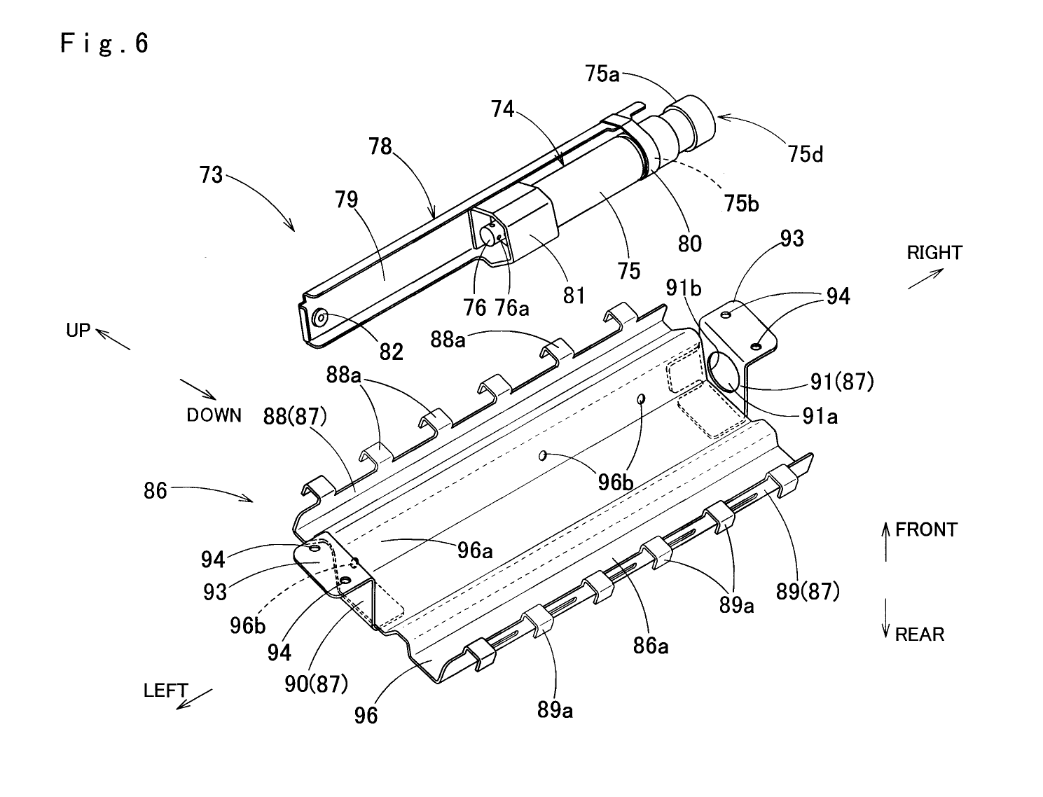

Referring to FIGS. 5 and 6, the retainer 78 includes a base 79 that has a generally rectangular plate shape elongated in a left and right direction, an annular belt portion 80 and a generally hexagonal cylindrical portion 81. The base 79 includes a plurality of bolts 82. In this embodiment, the bolts 82 are located on three positions; proximate left and right ends of and at the center in a left and right direction of the base 79. The cylindrical portion 81 is located proximate the center in a left and right direction of the base 79 in such a manner as to encircle the small-diameter portion 76 of the inflator body 74. The belt portion 80 is located proximate the right end of the base 79.

As shown in FIG. 5, if the bolt 82 located proximate the belt portion 80 is fastened into a nut 84 on a later-described holding area 96a of the case 86 while having the outer circumference 75a of the front upper region of the root region of the large-diameter portion 75 away from the small-diameter portion 76 abutted on the inner circumference 91b of the insert hole 91a of the case 86, the inner circumference of the belt portion 80 pushes the outer circumference 75b of the rear lower portion of the large-diameter portion 75 upward and forward and the outer circumference 75c of the front upper portion of the leading end region of the large-diameter portion 75 abuts on and is supported by the base 79 and the head 82a of the bolt 82. Thus the retainer 78 secures the inflator body 74 to the case 86 in a stable manner.

The case 86 that houses the airbag 71 and inflator 73 is made of sheet metal and is mounted to the holder 33 as best shown in FIG. 4. The case 86 includes a generally square tubular circumferential wall 87, a front wall 96 that closes off the front side of the circumferential wall 87 and the opening 86a, at the rear side, which allows emergence of the airbag 71, and thus having a generally rectangular parallelepiped box shape.

As shown in FIGS. 5 and 6, the circumferential wall 87 includes an upper wall 88 extending rearward from the upper edge of the front wall 96, a lower wall 89 extending rearward from the lower edge of the front wall 96 so as to oppose the upper wall 88, a left side wall 90 and right side wall 91 extending rearward in parallel to each other from left and right edges of the front wall 96.

Referring to FIGS. 4 and 6, the front wall 96 extends generally vertically when mounted on the globe box door 20 and includes a holding area 96a to which the inflator 73 and airbag 71 are secured. The holding area 96a includes mounting holes 96b for receiving the bolts 82 of the retainer 78 of the inflator 73 to be nut 84 fastened.

As best shown in FIG. 6, each of the upper wall 88 and lower wall 89 of the circumferential wall 87 is provided with a plurality of hooks 88a/89a inserted into retaining holes 35a/36a of later-described upper wall 35/lower wall 36 of the holder 33 and retaining peripheries of the retaining holes 35a/36a. Each of the hooks 88a and 89a extends outwardly in a vertical direction from the rear ends of the upper wall 88 and lower wall 89 and then extends forward, thus having a J-shaped section as shown in FIG. 4. The hooks 88a and 89a hold the upper wall 35 and lower wall 36 of the holder 33 securely to help enable the tearable portion 26 and later-described tearable portion 43 of the holder 33 to tear smoothly when the door 100 comprised of the outer door 27 and holding panel 40 is pushed by the airbag 71 upon airbag deployment.

As shown in FIG. 6, the side walls 90 and 91 of the circumferential wall 87 respectively includes at the rear end a mounting tongue 93 extending outwardly for securing the case 86 to the mounting element 55. Each of the tongues 93 is provided with two mounting holes 94 for receiving fixing means or bolts 98 from the front side, which bolts are further inserted through screw holes 56 of the mounting element 55 and fasten the tongue 93 to the mounting element 55.

The right side wall 91 further includes a though hole 91c for receiving the root-side end 75d of the inflator body 74 such that the root-side end 75d projects from the case 86 for connection with the above-described connector C for activation of the airbag.

The airbag 71, inflator 73 and the case 86 are preliminarily assembled into an airbag assembly SA for mounting on the holder 33. The assembling is conducted as follows: The retainer 78 of the inflator 73 is stored inside the airbag 71 such that the bolts 82 project out of the airbag 71. Then the airbag 71 is folded up. When folded up, the airbag 71 is wrapped up by a wrapping member for keeping the folded-up configuration. Subsequently, inserting the bolts 82 into the mounting holes 96b of the holding area 96a of the case 86, the folded-up airbag 71 is housed in the case 86. Subsequently, the inflator body 74 is set in from the insert hole 91a of the case 86 so as to run through the belt portion 80 and cylindrical portion 81 of the retainer 78 housed inside the airbag 71, and then the bolts 82 are fastened into nuts 84. Thus the airbag assembly SA is completed.

The holder 33 is fabricated of soft synthetic resin which is more flexible than the outer panel 21. In other words, the outer panel 21 is fabricated of hard synthetic resin which is rigider than the holder 33. In this specific embodiment, the later-described holding panel 40 and joint flange 46 of the holder 33 are vibration-welded to the outer door 27 and peripheral region 23a of the outer panel 21, and accordingly, the holder 33 is fabricated of thermo-plastic elastomer of olefin which is homogenous to the outer panel 21 of polypropylene so the welding is done easily.

As shown in FIGS. 4 and 7 to 9, the holder 33 includes a circumferential wall 34, a holding panel 40, a joint flange 46, and a pair of mounting beds 47. The circumferential wall 34 is formed into a generally square cylindrical shape extending in a generally anteroposterior direction and encircling the case 86 on above, below, left and right. The circumferential wall 34 includes an upper wall 35 and lower wall 36 opposing each other in a vertical direction and a left side wall 37 and right side wall 38 opposing each other in a left and right direction. In this embodiment, the upper wall 35, lower wall 36, left side wall 37 and right side wall 38 are coupled to one another into a cylinder.

The upper wall 35 and lower wall 36 are respectively provided with a plurality of retaining holes 35a/36a arranged along a left and right direction for engagement with the hooks 88a/89a of the upper wall 88/lower wall 89 of the case 86.

The left side wall 37 and right side wall 38 are respectively provided with a recess 37a/38a which recesses from the front end. The recesses 37a and 38a allow the mounting tongues 93 extending from the left side wall 90 and right side wall 91 of the case 86 and the end region 75d of the inflator 73 to protrude from the circumferential wall 34.

The joint flange 46 extends outwardly from rear ends of the upper wall 35, lower wall 36, left side wall 37 and right side wall 38 of the circumferential wall 34 and vibration-welded to the fore face of a generally square annular area of the rear panel portion 23 encircling the tearable portion 26 of the outer panel 21, i.e. the peripheral region 23a.

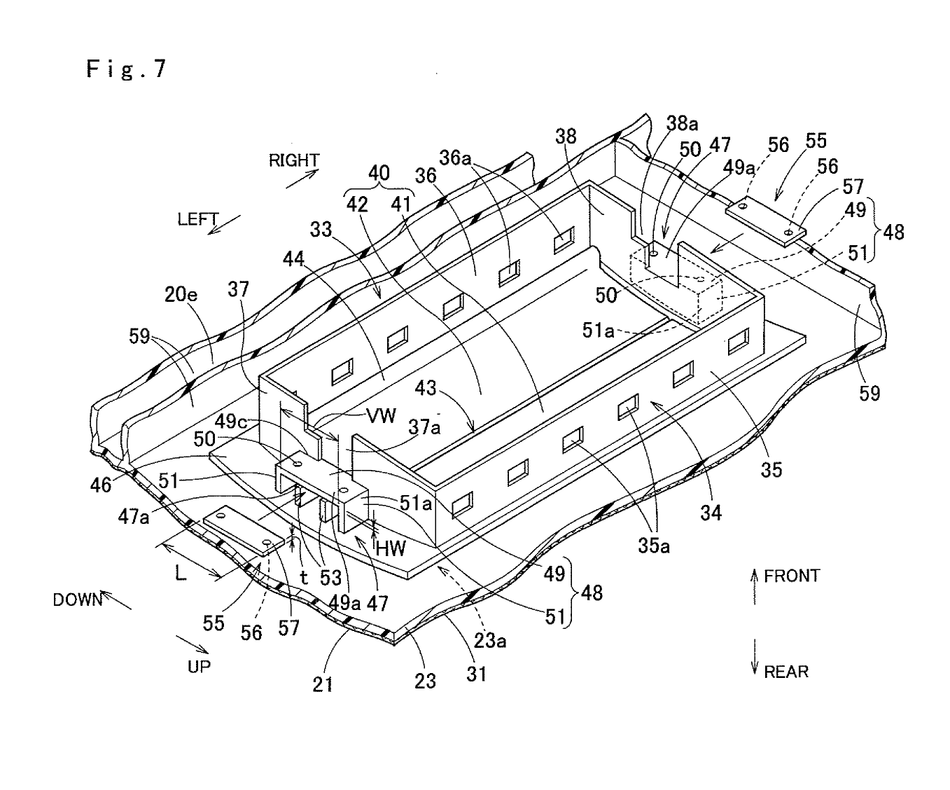

The holding panel 40 includes an upper section 41 and a lower section 42 each having a rectangular plate shape alike the upper flap 28 and lower flap 29 of the outer door 27. The upper section 41 and lower section 42 are configured openeable. Specifically, the upper section 41 is provided on the top with a U-curved portion which is continuous with the upper wall 35 of the circumferential wall 34 and acts as a hinge 44 when opening upward. The lower section 42 is located below the upper section 41 and is provided at the bottom with a U-curved portion which is continuous with the lower wall 36 and acts as a hinge 44 when opening downward. Between the lower end of the upper section 41 and the upper end of the lower section 42 is a thinned or weakened tearable portion 43 which is tearable when pushed by the airbag 71 under inflation. The tearable portion 43 is formed into a straight line when viewed from the rear. As shown in FIGS. 7 and 9, laterals of the upper section 41 and lower section 42 are separated from the left side wall 37 and right side wall 38 of the circumferential wall 34 of the holder 33. The upper section 41 and lower section 42 may be separated in advance instead of providing the tearable portion 43.

The upper section 41 and lower section 42 are respectively coupled to the fore faces of the upper flap 28 and lower flap 29 of the outer door 27 by vibration welding. When the upper section 41 and lower section 42 open upward and downward about the hinges 44 upon airbag deployment, the upper flap 28 and lower flap 29 break away from the peripheral region 23a of the rear panel portion 23 due to the tear of the tearable portion 26. However, since the upper section 41 and lower section 42 are coupled to and hold the flaps 28 and 29, and the upper wall 35 and lower wall 36 of the circumferential wall 34 of the holder 33 indirectly hold the flaps 28 and 29 via the hinges 44, the flaps 28 and 29 are prevented from being blown off.

The mounting beds 47 are located on the outside of the left side wall 37 and right side wall 38 of the circumferential wall 34 of the holder 33. More specifically, the mounting beds 47 are respectively formed on an area extending from the rear side of the recesses 37a/38a to the joint flange 46. As described later, the mounting elements 55 are assembled with the mounting beds 47 and the mounting beds 47 hold the mounting elements 55 from moving forward or backward.

Mounting elements 55 are provided to assist mounting of the case 86 to the holder 33 and are formed into a plate, respectively, in this specific embodiment. Each of the mounting elements 55 includes a plate 57 formed of a sheet metal having a rectangular shape, two screw holes 56 formed along the length direction of the plate 57 and two nuts 58 welded to peripheries of the screw holes 56. The mounting element 55 as mounted on board is so arranged that the plate 57 extends vertically and the screw holes 56 are arranged one above the other and have their axial directions extending in an anteroposterior direction. The above-described mounting tongues 93 of the case 86 are secured to the mounting element 55.

As shown in FIGS. 7 to 9, each of the mounting beds 47 includes a front regulating region 48 that abuts against the fore face 55a of the mounting element 55 and prevents forward movement of the mounting element 55 and a rear regulating region 53 that abuts against the back face 55b of the mounting element 55 and prevents backward movement of the mounting element 55. Each of the mounting elements 55 is set into a slot 47a provided between the front regulating region 48 and rear regulating region 53 of each of the mounting beds 47, and thus mounted to the holder 33.

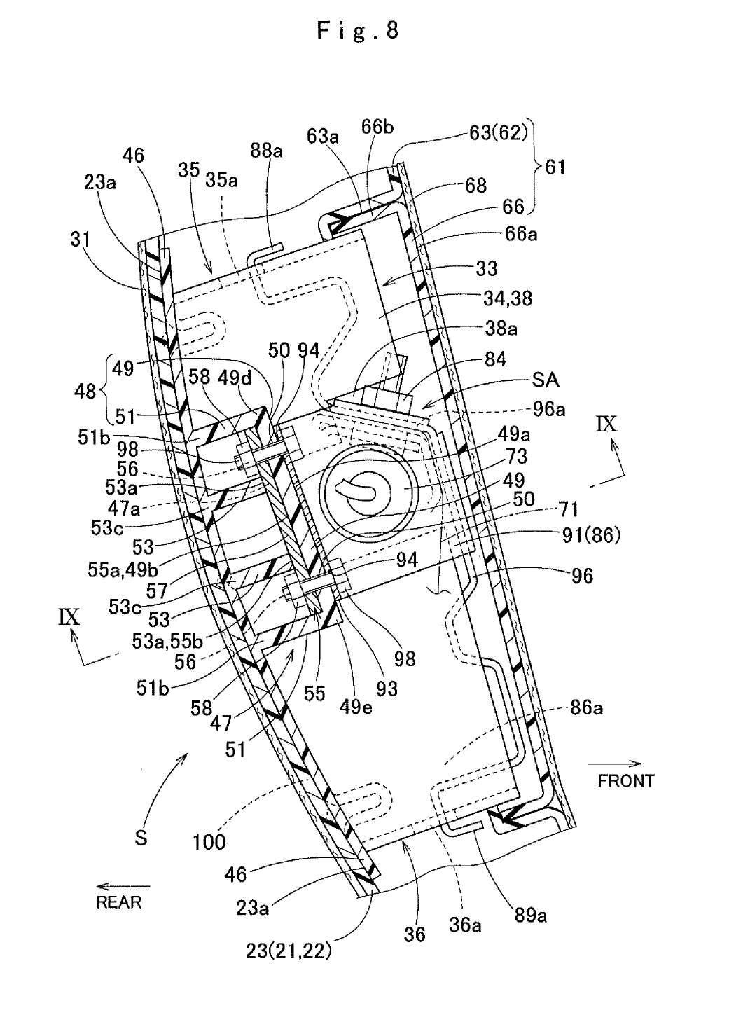

In this embodiment, the front regulating region 48 has a section shaped like a generally “U” lying on its side as shown in FIGS. 7 and 8, and has a front wall 49 and two support walls 51. Two rear regulating regions 53 are provided to support the rear face 55b of the mounting element 55 by the front faces or front ends 53a in the vicinity of the screw holes 56. Each of the rear regulating regions 53 is formed into a rectangular plate shape extending generally along a horizontal direction. Inner ends 53b (FIG. 9) of the rear regulating regions 53 facing toward the circumferential wall 34 of the holder 33 are entirely coupled to the left side wall 37 or right side wall 38 of the circumferential wall 34 whereas rear ends 53c (FIG. 8) are entirely coupled to the joint flange 46.

The front wall 49 of the front regulating region 48 is formed into a rectangular plate shape extending vertically for abutment against the fore face 55a of the mounting element 55 on the rear face 49b to prevent the mounting element 55 from moving forward. The inner end 49c of the front wall 49 facing toward the circumferential wall 34 of the holder 33 is coupled to the left side wall 37 or right side wall 38 of the circumferential wall 34. Each of the support walls 51 is formed into a rectangular plate shape extending rearward from the upper/lower end 49d/49e of the front wall 49. Inner ends 51a (FIG. 7) of the support walls 51 facing toward the circumferential wall 34 are coupled to the left side wall 37 or right side wall 38 of the circumferential wall 34 whereas rear ends 51b (FIG. 8) are coupled to the joint flange 46.

In this embodiment, the rear regulating regions 53 are located between the support walls 51, such that a space defined by the support walls 51, the fore faces 53a of the rear regulating regions 53 and the rear face 49b of the front wall 49 acts as the insert slot 47a for receiving the mounting element 55. That is, referring to FIG. 7, the dimension HW in an anteroposterior direction of the insert slot 47a is generally equal to (slightly smaller than) the thickness t of the plate 57 of the mounting element 55, and the vertical dimension VW is generally equal to the vertical dimension L of the plate 57. Thus, when inserted into the slots 47a from sides of the left or right side wall 37/38 of the circumferential wall 34, the mounting elements 55 are positioned, prevented from movement in an anteroposterior direction.

The front wall 49 of each of the front regulating regions 48 includes on locations corresponding to the screw holes 56 of the mounting element 55 through holes 50, round in shape, for receiving the bolts 98 acting as fixing means. Needless to add, the through holes 50 and screw holes 56 of the mounting element 55 are formed on locations corresponding to the mounting holes 94 of each of the mounting tongues 93 of the case 86.

Moreover, as shown in FIG. 4, a skin layer 31 of woven fabric, nonwoven fabric or the like is adhered to the rear face of the outer panel 21 so as to appear on the rear face 20d of the glove box door 20. The skin layer 31 is tearable when the outer door 27 opens. A skin layer 68 of woven fabric, nonwoven fabric or the like is adhered to the fore face of the inner panel 61, i.e. fore faces of the cover panel 66 and peripheral panel 62, so as to appear on the fore face 20c of the glove box door 20.

Manufacturing of the glove box door 20 is started by providing the outer panel 21 having the reinforcing ribs 59, the holder 33, the peripheral panel 62 and cover panel 66 of the inner panel 61, the mounting elements 55 and the airbag assembly SA. Then the outer panel 21 is subjected to suitable cutting operation by an end mill or the like to form the tearable portion 26. Thereafter, the holder 33 is coupled to the outer panel 21 by vibration welding. At this time, the upper section 41 and lower section 42 of the holding panel 40 of the holder 33 are respectively welded to the upper flap 28 and lower flap 29 of the outer door 27 whereas the joint flange 46 is welded to the peripheral region 23a of the rear panel portion 23. The welding strength is so determined that welded regions may not be separated when the door 100 is pushed by the airbag 71 at deployment.

Each of the mounting elements 55 is inserted into the slot 47a and assembled with the mounting bed 47. The mounting elements 55 may be attached to the mounting beds 47 before mounting the holder 33 on the outer panel 21.

Subsequently, the outer panel 21 is coupled to the peripheral panel 62 of the inner panel 61 by vibration-welding the front ends 59a of the reinforcing ribs 59 to the peripheral panel 62.

Then the airbag assembly SA is set inside the circumferential wall 34 of the holder 33 such that the hooks 88a and 89a of the case 86 are inserted into the retaining holes 35a and 36a of the upper wall 35 and lower wall 36 of the circumferential wall 34 and engage with peripheries thereof whereas the mounting tongues 93 of the case 86 abut on the fore faces 49a of the front walls 49 of the left and right mounting beds 47. The bolts 98 are then fastened into the screw holes 56 of the mounting elements 55 via the mounting holes 94 and through holes 50, thus securing the tongues 93 to the mounting elements 55 attached to the holder 33. Thus the airbag apparatus S is mounted on the outer panel 21.

Thereafter, the cover panel 66 is so assembled with the peripheral panel 62 of the inner panel 61 as to cover the airbag apparatus S by fitting the flanges 66b into the fitting portions 63a of the front panel portion 63 of the peripheral panel 62, and the surface skins 31 and 68 are adhered to the outer circumference, thereby completing the glove box door 20 provided with the airbag apparatus S. The surface skin 31 may alternatively be applied on the outer panel 21 before the welding of the outer panel 21 and peripheral panel 62 of the inner panel 61, or after the welding and before the assembling of the cover panel 66 with the peripheral region 26.

The glove box door 20 thus manufactured is assembled with the box body 14 to complete the glove box 13. The glove box 13 is then mounted on a vehicle whereas the lead wire R extending from the activating circuit is connected to the inflator body 74 via not-shown apertures formed on the box body 14 and inner panel 61. Thus the glove box 13 is installed on the vehicle together with the airbag apparatus S.

If an actuating signal is fed to the inflator body 74 via the lead wire R, the inflator 73 discharges inflation gas from the gas discharge ports 76a. Then the airbag 71 inflates and pushes the door 100 which is comprised of the outer door 27 (upper flap 28 and lower flap 29) of the outer panel 21 and the holding panel 40 (upper section 41 and lower section 42) of the holder 33, breaks the tearable portion 26 formed around the outer door 27 of the outer panel 21 and opens the upper region 101 and lower region 102 of the door 100 upward and downward about the hinges 44.

Then the airbag 71 emerges from the emergence opening 86a of the case 86, protrudes rearward from the outer panel 21 and deploys in front of knees K of an occupant M as shown in FIG. 3. The deployed airbag 71 properly cushions and protects the knees K moving forward.

At this time, the airbag 71 emerged from the glove box door 20 stably receives the knees K without moving since the hinge pins 17, latches, rear end faces 14b (FIGS. 2 and 3) of the box body 14 position the glove box door 20 relative to the box body 14 and prevents it from moving in anteroposterior, lateral and vertical directions.

As shown in FIGS. 1 and 2, an airbag apparatus 8 for a front passenger's seat is installed above the glove box 13 for protecting an upper body of the occupant M. The airbag apparatus 8 is mounted on an interior of the top face of the instrument panel 4 and includes an airbag 8a, an inflator 8b for feeding inflation gas to the airbag 8a, a case 8c encasing the airbag 8a and inflator 8b, and an airbag cover 8d covering the top of the case 8c and provided with a door 8e for opening when pushed by the airbag 8a under inflation. The airbag cover 8d in the illustrated embodiment is integral with the instrument panel 4. The airbag apparatus 8 is bolt 9 fixed to a bracket 2a secured to an instrument panel reinforcement 2, which is part of the vehicle body structure 1, by a bracket 8f extending from the case 8c. The airbag apparatus 8 is actuated simultaneously with the knee-protecting airbag apparatus S and the airbag 8a pushes and opens the airbag cover 8d and deploys to protect the upper body of the occupant M seated in the front passenger's seat.

When the airbag apparatus S mounted on the glove box door 20 is activated, the airbag 71 under inflation pushes the outer door 27 and holding panel 40 of the door 100 rearward, away from the case 86. On the contrary, the case 86 is subjected to a reaction force of the airbag 71, which acts forward. However, the mounting tongues 93 of the case 86 extending toward the left and right from opposite sides of the circumferential wall 87 are secured to the mounting elements 55 that are assembled with the holder 33 and prevented from moving forward or backward by the holder 33. Accordingly, the case 86 is prevented from moving forward by the holder 33. Moreover, the area of the outer panel 21 encircling the outer circumference of the tearable portion 26, i.e. the peripheral region 23a, is prevented from moving backward since the joint flange 46 of the holder 33 is joined to the fore face of the peripheral region 23a. That is, it is prevented that the peripheral region 23a of the outer panel 21 and mounting tongues 93 of the case 86 move away from each other in an anteroposterior direction. With this configuration, if pushed by the airbag 71, the outer door 27 of the outer panel 21 smoothly break away from the peripheral region 23a due to tear of the tearable portion 26, and opens around the hinges 44 of the holder 33 together with the holding panel 40.

As a result, the airbag 71 smoothly emerges from an opening 25 (FIG. 4) provided by the opening of the door 100 and deploys rearward without being adversely affected by the outer panel 21.

The case 86 is secured to the holder 33 and the holder 33 is coupled to the outer panel 21 by the joint flange 46. That is, the case 86 is mounted on the outer panel 21 through intermediary of the holder 33, but is not directly mounted to the inner panel 61. Accordingly, even when subjected to a forward force upon airbag deployment, the case 86 will not so act as to disconnect the inner panel 61 from the outer panel 21. Furthermore, the outer panel 21 is fabricated of rigid synthetic resin such as filler-reinforced polypropylene, which has higher rigidity than the holder 33 that is formed of thermo-plastic elastomer of olefin in view of flexibility of the hinges 44, and therefore, the outer panel 21 holds the case 86 through intermediary of the holder 33 in a stable manner.

Further, after airbag deployment, although the inertia force of the airbag 71 pulls the case 86 to the rear, the mounting elements 55 to which the mounting tongues 93 of the case 86 are secured are prevented from moving rearward by the rear regulating regions 53, and are secured to the rigid outer panel 21 by intermediary of the holder 33. Thus the case 86 is stably held by the outer panel 21 as well after deployment of the airbag 71.

Moreover, a plurality of the reinforcing ribs 59 are provided between and connect the outer panel 21 and inner panel 61 around the airbag apparatus S in such a manner as to form a plurality of void spaces 20e between the panels 21 and 61. The void spaces 20e conduce to lighten the weight of the glove box door 20 and the ribs 59 improve flexural and torsional rigidity of the door 20.

Therefore, the glove box door 20 is rigid and light in weight although having the airbag apparatus S, and deploys the airbag 71 in a smooth fashion.

The upper wall 35 and lower wall 36 of the circumferential wall 34 of the holder 33 are retained by the hooks 88a and 89a of the case 86 and therefore held from moving to the rear. This configuration further assures smooth tear of the tearable portion 26 of the outer door 27 and tearable portion 43 of the holding panel 40 upon airbag deployment because the tearable portions 26 and 43 are prevented from rearward movement.

In the glove box door 20 of the foregoing embodiment, moreover, each of the mounting elements 55 is formed into a generally plate shape. The holder 33 includes a pair of mounting beds 47 each of which includes the front regulating region 48 that regulates movement of the mounting element 55 on the front side and the rear regulating region 53 that regulates movement of the mounting element 55 on the rear side. Each of the mounting elements 55 is inserted into the slot 47a formed between the front regulating region 48 and rear regulating region 53 and thus attached to the holder 33.

That is, each of the mounting elements 55 is easily assembled with the holder 33 only by insertion into the slot 47a formed between the front regulating region 48 and rear regulating region 53 of the corresponding mounting bed 47. The mounting elements 55 assembled with the holder 33 are clamped by the front regulating regions 48 and rear regulating regions 53 and prevented from forward or rearward movement. Thus the mounting tongues 93 of the case 86 are secured to the mounting elements 55 in a stable manner.

Without considering this advantage, it will also be appreciated to mold the holder 33 and mounting elements 55 together by insert molding using the mounting elements 55 as inserts.

Moreover, the front regulating region 48 of each of the mounting beds 47 includes the front wall 49 that is connected to the circumferential wall 34 of the holder 33 and regulates movement of the mounting element 55 on the front side and a pair of support walls 51 that extend from upper end 49d and lower end 49e of the front wall 49 toward the joint flange 46 and coupled to the joint flange 46 while being connected to the circumferential wall 34 of the holder 33. The front regulating region 48 thus has a U-shaped section. Each of the mounting elements 55 includes the screw holes 56 for receiving the bolts 98 acting as fixing means whereas the front wall 49 of each of the mounting beds 47 includes round through holes 50 for receiving the bolts 98. The rear regulating region 53 of each of the mounting beds 47 are coupled to the circumferential wall 34 and joint flange 46 and supports vicinities of the screw holes 56 of the mounting element 55 at more than one positions (at two positions, in the illustrated embodiment) from the rear.

That is, both of the front regulating region 48 and rear regulating region 53 of each of the mounting beds 47 are coupled to both of the joint flange 46 and circumferential wall 34. The joint flange 46 extends vertically along the tearable portion 26 of the outer panel 21. The circumferential wall 34 has a cylindrical shape extending in an anteroposterior direction and surrounding the case 86. Coupled to these two parts of the holder 33 extending mutually orthogonally, the front regulating region 48 and rear regulating region 53 are enhanced in rigidity. Clamped by these front regulating region 48 and rear regulating region 53, the mounting elements 55 are positioned in a further stable fashion. Moreover, the front wall 49 of the front regulating region 48 is prevented from moving forward, i.e. moving away from the outer panel 21, by the support walls 51 coupled to the circumferential wall 46 and joint flange 46 at opposite ends (upper end 49d and lower end 49e) while abutting against the entire fore face 55a of the mounting element 55. Therefore the front wall 49 securely prevents the mounting element 55 from moving forward. In addition, the rear regulating regions 53 are coupled to the circumferential wall 34 and joint flange 46 and support vicinities of the screw holes 56 of the mounting element 55 at two positions from the rear. Therefore the rear regulating regions 53 securely prevent the mounting element 55 from moving rearward.

The inner panel 61 includes the cover panel 66 that is fabricated of synthetic resin and located in front of the airbag apparatus S and the peripheral panel 62 that is fabricated of synthetic resin as well and located around the cover panel 66. The reinforcing ribs 59 are integral with the outer panel 21 and welded to the peripheral panel 62, thus connecting the outer panel 21 and peripheral panel 62.

That is, the outer panel 21 and inner panel 61 are easily coupled together by welding the reinforcing ribs 59 extending from the outer panel 21 to the peripheral panel 62 of the inner panel 61. Additionally, this configuration provides firm connection between the reinforcing ribs 59, outer panel 21 and inner panel 61, thus preventing the inner panel 61 from moving away from the outer panel 21 and enhancing rigidity of the glove box door 20. Although the outer panel 21 and inner panel 61 are welded together by vibration-welding of the reinforcing ribs 59, the welded portions will stay intact upon airbag deployment since the inner panel 61 is not subjected to forward pressing force of the case 86 as described above.

Although the reinforcing ribs 59 in the foregoing embodiment are formed integrally with the outer panel 21, the reinforcing ribs 59 may be formed to extend rearward from the front panel portion 63 of the peripheral panel 62 of the inner panel 61 and welded to the outer panel 21 by vibration-welding.

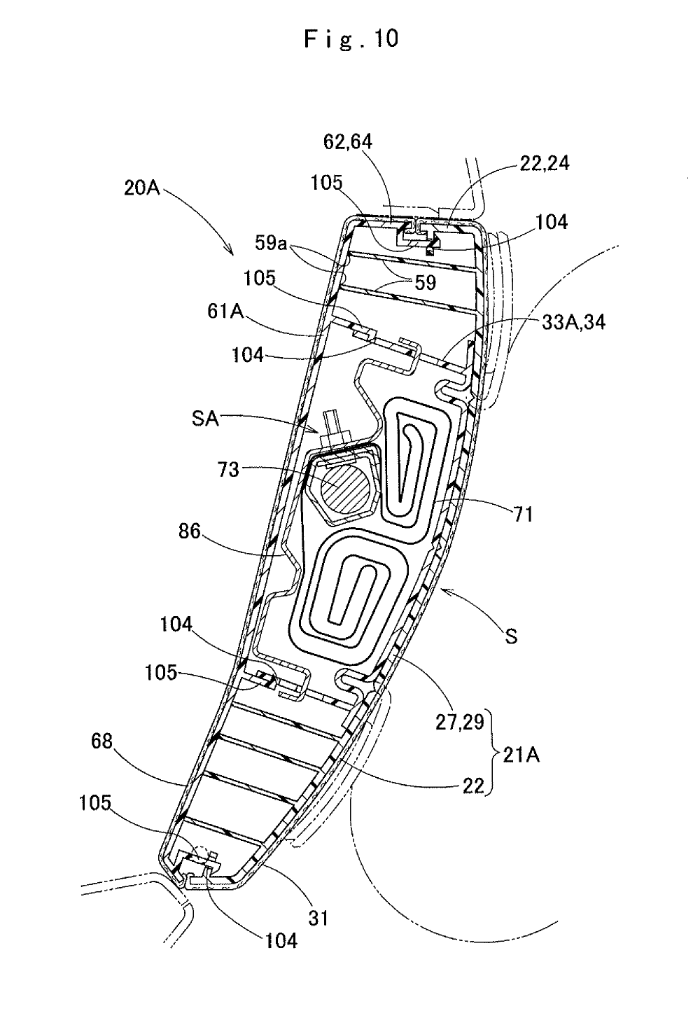

Although the inner panel 61 of the foregoing embodiment is comprised of two split parts; the peripheral panel 62 and cover panel 66, it may be formed of a single plate-shaped material as shown in FIG. 10. A glove box door 20A depicted in FIG. 10 has a similar structure to the glove box door 20 of the foregoing embodiment except in that an inner panel 61A is formed of a single plate-shaped material and coupled to the holder 33A and outer panel 21A by clip connection, adhesive and so on. The inner panel 61A includes a first engaging portion 105 having a flexible hook-like shape for engagement with a second engaging portion (engaging hole) 104 formed on the outer panel 21A and holder 33A. The inner panel 61A and outer panel 21A or holder 33A are coupled together by suitable adhesive in addition to engagement of the first engaging portion 105 and second engaging portion 104. The assembling of the inner panel 61A with the outer panel 21A and holder 33A is conducted after the installing of the airbag apparatus S on the holder 33A.

This configuration that the inner panel 61A is formed of a single plate-shaped material facilitates manufacturing of the glove box door 20A compared to the configuration of the foregoing embodiment in which the inner panel 61 is comprised of two split parts because it does not require a step for coupling the split parts.

In the glove box door 20/20A of the foregoing embodiments, the outer panel 21/21A includes the reinforcing ribs 59 integral with the outer panel 21/21A at least proximate the holder 33/33A. This configuration conduces to enhance rigidity of the outer panel 21 in the vicinity of the holder 33/33A, and thus assuring steady operation of the airbag apparatus S.

Although the mounting tongues 93 of the case 86 of the foregoing embodiments are formed on the left and right side walls 90 and 91, the mounting tongues 93 may alternatively be formed on the upper wall 88 and lower wall 89. It will also be appreciated to form one additional mounting tongue on the upper wall or lower wall in addition to those on the left and right side wall or form one additional on the left or right side wall in addition to those on the upper and lower walls. Further alternatively, mounting tongues 93 may be formed on four sides around the opening 86a of the case 86 for coupling with correspondingly-formed mounting elements 55 and mounting beds 47.

Although the door 100 opening to allow airbag emergence has been described as a double door that opens upward and downward, the door may be a single door that opens upward or downward.

What is claimed is:

1. A door of a glove box for installation in front of a seat of a vehicle, comprising:
an outer panel fabricated of synthetic resin and constituting a rear outer circumferential wall of the glove box door, the outer panel including an outer door region provided therearound with a weakened tearable portion;
an inner panel coupled to the outer panel and constituting a front outer circumferential wall of the glove box door;
an airbag apparatus located between the outer panel and the inner panel and comprising:
an inflatable airbag for emergence from the outer door region of the outer panel;
an inflator that feeds inflation gas to the airbag;
a case that houses and holds the airbag and inflator, including:
a circumferential wall;
a front wall closing off the front side of the circumferential wall;
an opening that opposes the front wall for allowing emergence of the airbag; and
a pair of mounting tongues that are formed on opposite sides of the circumferential wall;
a holder that is fabricated of synthetic resin, the holder being coupled to the outer panel and holding the case in order to mount the case to the outer panel, including:
a circumferential wall that is mounted around the case and extend in a generally anteroposterior direction;
a holding panel that is joined with and extends from a rear end of the circumferential wall in such a manner as to cover the opening of the case, the holding panel being coupled to and holding the outer door region of the outer panel and provided with a flexible hinge located proximate the rear end of the circumferential wall; and
a joint flange extending from the rear end of the circumferential wall and coupled to an area of the outer panel encircling the outer circumference of the tearable portion; and
a pair of mounting elements assembled with the holder in such a manner as to be prevented from forward or backward movement for assisting the mounting of the case to the outer panel, the mounting tongues of the case being secured to the mounting elements by fixing means; and
a plurality of reinforcing ribs extending between and connecting the outer panel and inner panel around the airbag apparatus in such a manner as to form void spaces between the outer panel and inner panel, wherein:
the outer panel is fabricated of rigid synthetic resin relative to the holder; and
the outer door region of the outer panel and the holding panel of the holder form, in combination, a door that covers the opening of the case and opens at airbag deployment due to tear of the tearable portion of the outer door region to provide an emergence opening that allows emergence of the airbag.

2. The glove box door as set forth in claim 1, wherein:
each of the mounting elements is formed into a generally plate shape;
the holder includes a pair of mounting beds each of which includes a front regulating region that regulates movement of the mounting element on the front side and a rear regulating region that regulates movement of the mounting element on the rear side; and
each of the mounting elements is inserted into a space between the front regulating region and rear regulating region and thus assembled with the holder.

3. The glove box door as set forth in claim 2, wherein:
the front regulating region of each of the mounting beds includes a front wall that is connected to the circumferential wall of the holder and regulates movement of the mounting element on the front side, the front wall including a round through hole for receiving a bolt acting as the fixing means, and a pair of support walls that extend from opposite ends of the front wall toward the joint flange and coupled to the joint flange while being connected to the circumferential wall of the holder, the front regulating region thus having a “U” shaped section;
each of the mounting elements includes a screw hole for receiving the bolt; and
the rear regulating region of each of the mounting beds is coupled to the circumferential wall and joint flange of the holder and supports the vicinity of the screw hole of the mounting element at more than one locations from the rear.

4. The glove box door as set forth in claim 1, wherein:
the inner panel includes a cover panel that is fabricated of synthetic resin and located in front of the airbag apparatus and a peripheral panel that is fabricated of synthetic resin and located around the cover panel, the cover panel being coupled to the peripheral panel; and
the reinforcing ribs are integral with either the outer panel or the peripheral panel of the inner panel and welded to the peripheral panel or the outer panel.

5. The glove box door as set forth in claim 1, wherein the inner panel is formed of a single plate-shaped material.

6. The glove box door as set forth in claim 1, wherein at least part of the reinforcing ribs located in the vicinity of the holder is integral with the outer panel.
